(19) United States
(12) Patent Application Publication
(10) Pub. No.: US 2025/0215018 A1
(43) Pub. Date: Jul. 3, 2025

(54) QUANTUM DOT PRECURSOR, PREPARATION METHOD THEREOF AND QUANTUM DOT

(71) Applicants: Guangdong Juhua Research Institute of Advanced Display, Guangzhou (CN); TCL Technology Group Corporation, Huizhou (CN)

(72) Inventor: Hua JIANG, Guangzhou (CN)

(73) Assignees: Guangdong Juhua Research Institute of Advanced Display, Guangzhou, Guangdong (CN); TCL Technology Group Corporation, Huizhou, Guangdong (CN)

(21) Appl. No.: 18/990,909

(22) Filed: Dec. 20, 2024

(30) Foreign Application Priority Data
Dec. 29, 2023 (CN) 202311870689.9

(51) Int. Cl. C07F 3/06; C09K 11/88

(52) U.S. Cl. CPC C07F 3/06; C09K 11/883

(57) ABSTRACT

The present disclosure quantum dot precursor, preparation method thereof and quantum dot. A structural formula of the quantum dot precursor is shown in formula (I):

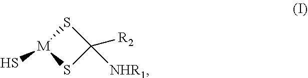

wherein the M is selected from metal. The quantum dot precursor provided by the present disclosure has high stability and consistency.

This application claims priority to Chinese Application No. 202311870689.9, entitled “QUANTUM DOT PRECURSOR, PREPARATION METHOD THEREOF AND QUANTUM DOT”, filed on Dec. 29, 2023. The entire disclosures of the above application are incorporated herein by reference.

### TECHNICAL FIELD

The present disclosure relates to a field of quantum dot technologies, and more particularly, to quantum dot precursor, preparation method thereof and quantum dot.

### BACKGROUND

Quantum dots have the advantages of saturated colour and adjustable wavelength of emitted light, and high photoluminescence quantum yield and electroluminescence quantum yield, which are widely used in the field of display technology.

Quantum dots are generally synthesized by quantum dot precursors, which are closely related to the stability of quantum dots. At present, the preparation methods of quantum dot precursors are complicated, and the stability of the prepared quantum dot precursors is poor, which needs to be further improved.

### TECHNICAL SOLUTION

In view of this, the present disclosure provides a quantum dot precursor, a preparation method thereof and a quantum dot.

The present disclosure provides a quantum dot precursor, and a structural formula of the quantum dot precursor is shown in formula (I):

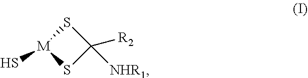

Wherein the M is selected from metal.

R₁ and R₂ are respectively selected from hydrogen, deuterium, halogen, cyano, hydroxyl, carboxyl, aldehyde, nitro, substituted or unsubstituted C₁-C₃₂ alkyl, substituted or unsubstituted C₁-C₃₂ heteroalkyl, substituted or unsubstituted C₂-C₃₂ alkenyl, substituted or unsubstituted C₂-C₃₂ heteroalkenyl, substituted or unsubstituted C₂-C₃₂ alkynyl, substituted or unsubstituted C₂-C₃₂ heteroalkynyl, substituted or unsubstituted C₁-C₃₂ alkoxy, substituted or unsubstituted —NR₃R₄, substituted or unsubstituted —SR₅, substituted or unsubstituted —PR₆R₇, substituted or unsubstituted C₁-C₃₂ acyloxy group, substituted or unsubstituted C₁-C₃₂ alkoxycarbonyl group, substituted or unsubstituted C₆-C₂₀ aryl group, and substituted or unsubstituted heterocyclic groups with 3-20 ring atoms.

R₃, R₄, R₅, R₆ and R₇ are respectively selected from hydrogen, deuterium, halogen, cyano, hydroxyl, carboxyl, aldehyde, nitro, substituted or unsubstituted C₁-C₃₂ alkyl, substituted or unsubstituted C₁-C₃₂ heteroalkyl, substituted or unsubstituted C₂-C₃₂ alkenyl, substituted or unsubstituted C₂-C₃₂ heteroalkenyl, substituted or unsubstituted C₂-C₃₂ alkynyl, substituted or unsubstituted C₂-C₃₂ heteroalkynyl, substituted or unsubstituted C₁-C₃₂ alkoxy, substituted or unsubstituted —PR₆R₇, substituted or unsubstituted C₁-C₃₂ acyloxy group, substituted or unsubstituted C₁-C₃₂ alkoxycarbonyl group, substituted or unsubstituted C₆-C₂₀ aryl group, and substituted or unsubstituted heterocyclic groups with 3-20 ring atoms.

A heteroatom in the heteroalkyl group, the heteroalkenyl group, the heteroalkynyl group and the heterocyclic group is selected from one or more of N, S, O, P and Si.

A substituted substituent in the substituted groups is independently selected from one or more of —NH, —F, —Cl, —Br, —I, —OH, —COOH, —NO₂, —SO₃H, —CHO, —SH, —OH, —OOCCH₃ and —CN.

Alternatively, R₁ and R₂ are respectively selected from hydrogen, deuterium, halogen, cyano, hydroxyl, carboxyl, aldehyde, nitro, substituted or unsubstituted C₁-C₂₀ alkyl, substituted or unsubstituted C₁-C₂₀ heteroalkyl, substituted or unsubstituted C₂-C₂₀ alkenyl, substituted or unsubstituted C₂-C₂₀ heteroalkenyl, substituted or unsubstituted C₂-C₂₀ alkynyl, substituted or unsubstituted C₂-C₂₀ heteroalkynyl, substituted or unsubstituted C₁-C₂₀ alkoxy, substituted or unsubstituted —NR₃R₄, substituted or unsubstituted —SR₅, substituted or unsubstituted —PR₆R₇, substituted or unsubstituted C₁-C₂₀ acyloxy group, substituted or unsubstituted C₁-C₂₀ alkoxycarbonyl group, substituted or unsubstituted C₆-C₁₅ aryl group, and substituted or unsubstituted heterocyclic groups with 3-15 ring atoms.

Alternatively, R₁ is selected from C₂-C₁₈ alkyl.

Alternatively, R₃, R₄, R₅, R₆ and R₇ are respectively selected from hydrogen, deuterium, halogen, cyano, hydroxyl, carboxyl, aldehyde, nitro, substituted or unsubstituted C₁-C₂₀ alkyl, substituted or unsubstituted C₁-C₂₀ heteroalkyl, substituted or unsubstituted C₂-C₂₀ alkenyl, substituted or unsubstituted C₂-C₂₀ heteroalkenyl, substituted or unsubstituted C₂-C₂₀ alkynyl, substituted or unsubstituted C₂-C₂₀ heteroalkynyl, substituted or unsubstituted C₁-C₂₀ alkoxy, substituted or unsubstituted C₁-C₂₀ acyloxy group, substituted or unsubstituted C₁-C₂₀ alkoxycarbonyl group, substituted or unsubstituted C₆-C₁₅ aryl group, and substituted or unsubstituted heterocyclic groups with 3-15 ring atoms.

Alternatively, R₂ is selected from substituted or unsubstituted C₁-C₃₂ alkoxy, substituted or unsubstituted —NR₃R₄, substituted or unsubstituted —SR₅, and substituted or unsubstituted —PR₆R₇.

Alternatively, R₂ is selected from one of —N(C₂H₅)₂, —OC₁₆H₃₃, —SC₁₆H₃₃, and —NHC₁₆H₃₃.

Alternatively, the M is selected from divalent metal, and the divalent metal is selected from one of Zn, Cd, Pb, Hg, Cu, Ni and Mn.

Alternatively, the quantum dot precursor is selected from one of the following formulas:

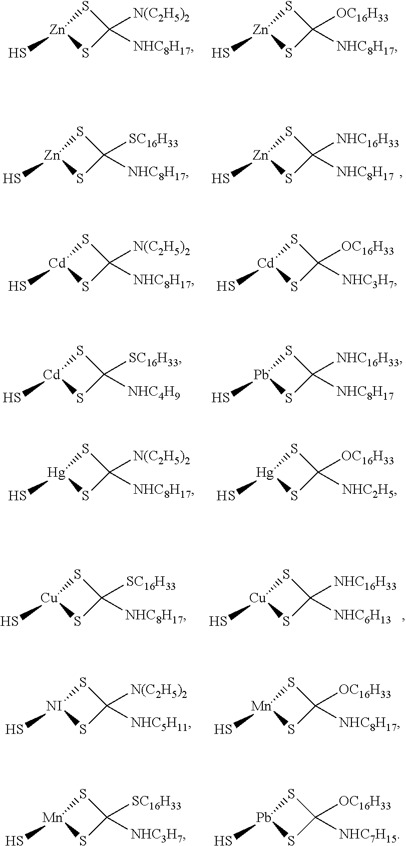

The present disclosure provides a preparation method of a quantum dot precursor, including: providing a dispersion is provided, and the dispersion includes a compound A and a solvent; and providing a compound B, mixing the compound B and the dispersion to obtain a quantum dot precursor; wherein a chemical formula of the compound B is R₉—NH₂; and a structural formula of the compound A is selected from one of formula (II) and formula (III):

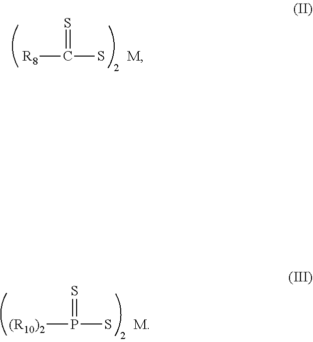

Wherein R₈, R₉ and R₁₀ are respectively selected from hydrogen, deuterium, halogen, cyano, hydroxyl, carboxyl, aldehyde, nitro, substituted or unsubstituted C₁-C₃₂ alkyl, substituted or unsubstituted C₁-C₃₂ heteroalkyl, substituted or unsubstituted C₂-C₃₂ alkenyl, substituted or unsubstituted C₂-C₃₂ heteroalkenyl, substituted or unsubstituted C₂-C₃₂ alkynyl, substituted or unsubstituted C₂-C₃₂ heteroalkynyl, substituted or unsubstituted C₁-C₃₂ alkoxy, substituted or unsubstituted —NR₃R₄, substituted or unsubstituted —SR₅, substituted or unsubstituted —PR₆R₇, substituted or unsubstituted C₁-C₃₂ acyloxy group, substituted or unsubstituted C₁-C₃₂ alkoxycarbonyl group, substituted or unsubstituted C₆-C₂₀ aryl group, and substituted or unsubstituted heterocyclic groups with 3-20 ring atoms.

R₃, R₄, R₅, R₆ and R₇ are respectively selected from hydrogen, deuterium, halogen, cyano, hydroxyl, carboxyl, aldehyde, nitro, substituted or unsubstituted C₁-C₃₂ alkyl, substituted or unsubstituted C₁-C₃₂ heteroalkyl, substituted or unsubstituted C₂-C₃₂ alkenyl, substituted or unsubstituted C₂-C₃₂ heteroalkenyl, substituted or unsubstituted C₂-C₃₂ alkynyl, substituted or unsubstituted C₂-C₃₂ heteroalkynyl, substituted or unsubstituted C₁-C₃₂ alkoxy, substituted or unsubstituted —PR₆R₇, substituted or unsubstituted C₁-C₃₂ acyloxy group, substituted or unsubstituted C₁-C₃₂ alkoxycarbonyl group, substituted or unsubstituted C₆-C₂₀ aryl group, and substituted or unsubstituted heterocyclic groups with 3-20 ring atoms.

A heteroatom in the heteroalkyl group, the heteroalkenyl group, the heteroalkynyl group and the heterocyclic group is selected from one or more of N, S, O, P and Si.

A substituted substituent in the substituted groups is independently selected from one or more of —NH, —F, —Cl, —Br, —I, —OH, —COOH, —NO₂, —SO₃H, —CHO, —SH, —OH, —OOCCH₃ and —CN.

Alternatively, R₈, R₉ and R₁₀ are respectively selected from hydrogen, deuterium, halogen, cyano, hydroxyl, carboxyl, aldehyde, nitro, substituted or unsubstituted C₁-C₂₀ alkyl, substituted or unsubstituted C₁-C₂₀ heteroalkyl, substituted or unsubstituted C₂-C₂₀ alkenyl, substituted or unsubstituted C₂-C₂₀ heteroalkenyl, substituted or unsubstituted C₂-C₂₀ alkynyl, substituted or unsubstituted C₂-C₂₀ heteroalkynyl, substituted or unsubstituted C₁-C₂₀ alkoxy, substituted or unsubstituted —NR₃R₄, substituted or unsubstituted —SR₅, substituted or unsubstituted —PR₆R₇, substituted or unsubstituted C₁-C₂₀ acyloxy group, substituted or unsubstituted C₁-C₂₀ alkoxycarbonyl group, substituted or unsubstituted C₆-C₁₅ aryl group, and substituted or unsubstituted heterocyclic groups with 3-15 ring atoms.

R₃, R₄, R₅, R₆ and R₇ are respectively selected from hydrogen, deuterium, halogen, cyano, hydroxyl, carboxyl, aldehyde, nitro, substituted or unsubstituted C₁-C₂₀ alkyl, substituted or unsubstituted C₁-C₂₀ heteroalkyl, substituted or unsubstituted C₂-C₂₀ alkenyl, substituted or unsubstituted C₂-C₂₀ heteroalkenyl, substituted or unsubstituted C₂-C₂₀ alkynyl, substituted or unsubstituted C₂-C₂₀ heteroalkynyl, substituted or unsubstituted C₁-C₂₀ alkoxy, substituted or unsubstituted C₁-C₂₀ acyloxy group, substituted or unsubstituted C₁-C₂₀ alkoxycarbonyl group, substituted or unsubstituted C₆-C₁₅ aryl group, and substituted or unsubstituted heterocyclic groups with 3-15 ring atoms.

Alternatively, R₉ is selected from C₂-C₁₈ alkyl.

R₈ and R₁₀ are respectively selected from substituted or unsubstituted C₁-C₃₂ alkoxy, substituted or unsubstituted —NR₃R₄, substituted or unsubstituted —SR₅, and substituted or unsubstituted —PR₆R₇; and R₈ and R₁₀ are respectively selected from one of —N(C₂H₅)₂, —OC₁₆H₃₃, —SC₁₆H₃₃, and —NHC₁₆H₃₃.

Alternatively, the M is selected from divalent metal, and the divalent metal is selected from one of Zn, Cd, Pb, Hg, Cu, Ni and Mn.

Alternatively, the compound A is selected from one of M(DDTC)₂,

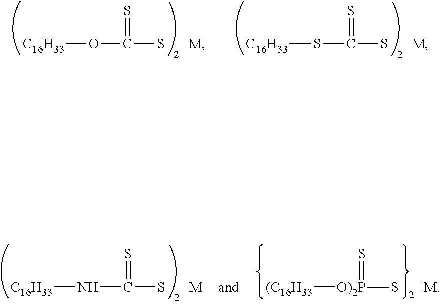

Alternatively, the compound B is selected from one of n-octylamine, heptamine, ethylamine, butylamine, dodecylamine and octadecylamine.

Alternatively, the solvent is selected from octadecene.

Alternatively, a molar concentration of the compound A in the dispersion ranges between 0.05 mmol/mL-0.2 mmol/mL; and a molar ratio of the compound A to the compound B is 1:(1-4).

Alternatively, a mixing of the compound A and the compound B is performed under bubbling.

A reaction of the compound A and the compound B is performed under room temperature; and a reaction time of the compound A and the compound B ranges between 2 min-15 min.

Alternatively, a method for mixing the compound B and the dispersion includes: adding the compound B into the dispersion in batches.

The present disclosure provides a quantum dot, the quantum dot is prepared from the quantum dot precursor according above-mentioned.

Alternatively, the quantum dot is a core-shell quantum dot, and a shell layer of the core-shell quantum dot is prepared from the quantum dot precursor; and the quantum dot is blue quantum dot.

The quantum dot precursor provided by the present disclosure has high stability and consistency.

### BRIEF DESCRIPTION OF DRAWINGS

In order to more clearly explain the technical solutions in the embodiments of the present disclosure, the following will briefly introduce the drawings required in the description of the embodiments. Obviously, the drawings in the following description are only some embodiments of the present disclosure. For those skilled in the art, without paying any creative work, other drawings can be obtained based on these drawings.

FIG. 1 is a flowchart of a method for preparing a quantum dot precursor according to an embodiment of the present disclosure.

FIG. 2 is a NMR spectrum of quantum dot precursors according to Examples 1-4 and Comparative Example 1 of the present disclosure.

FIG. 3 is an external view of quantum dot precursors according to Example 1 and Comparative Example 1 of the present disclosure.

FIG. 4 is an infrared spectrum of octadecene, n-octylamine, Zn(DDTC)₂ and mixed solution of quantum dot precursor according to Example 1 of the present disclosure.

FIG. 5 is a partial enlarged view of the infrared spectrum of FIG. 4 at a wavelength of 900 cm⁻¹ to 1500 cm⁻¹.

FIG. 6 is a photoluminescence spectrum of quantum dots according to Quantum dot Example 1 and Quantum dot Comparative Example 1 of the present disclosure.

### DETAILED DESCRIPTION

Technical solutions in embodiments of the present disclosure will be clearly and completely described below in conjunction with drawings in the embodiments of the present disclosure. Obviously, the described embodiments are only a part of embodiments of the present disclosure, rather than all the embodiments. Based on the embodiments in the present disclosure, all other embodiments obtained by those skilled in the art without creative work fall within the protection scope of the present disclosure.

Additionally, in the description of the present disclosure, the term “comprising/including” means “comprising/including but not limited to.” Various embodiments of the present disclosure may be presented in a form of range. The description in the form of range is merely for convenience and brevity, and should not be construed as a hard limitation on the scope of the disclosure. Accordingly, it should be considered that the recited range description has specifically disclosed all possible subranges, as well as a single numerical value within that range. For example, it should be considered that a description of a range from 1 to 6 has specifically disclosed subranges, such as from 1 to 3, from 1 to 4, from 1 to 5, from 2 to 4, from 2 to 6, from 3 to 6, etc., and a single number within the range, such as 1, 2, 3, 4, 5, and 6, regardless of the range. Whenever a range of values is indicated herein, it is meant to include any recited number (fraction or integer) within the indicated range.

In the present disclosure, the term “and/or” is used to describe the association of associated objects, and means that there may be three relationships, for example, “A and/or B” may refer to three cases: the first case refers to the presence of A alone; the second case refers to the presence of both A and B; the third case refers to the presence of B alone, where A and B may be singular or plural.

In the present disclosure, the term “at least one” refers to one or more, and “a plurality of/multiple” refers to two or more. The terms “at least one”, “at least one of the followings”, or the like, refer to any combination of the items listed, including any combination of the singular or the plural items. For example, “at least one of a, b, or c” or “at least one of a, b, and c” may refer to: a, b, c, a-b (i.e., a and b), a-c, b-c, or a-b-c, where a, b, and c may be single or plural.

In the present disclosure, “alkyl” may mean linear alkyl, branched alkyl and/or cyclic alkyl. The carbon number of the alkyl group might be 1 to 30, 1 to 25, 1 to 20, 1 to 15, 1 to 10 or 1 to 6. The phrase containing this term, for example, “C₁-C₉ alkyl” refers to an alkyl group containing 1 to 9 carbon atoms, and each occurrence might be C₁ alkyl, C₂ alkyl, C₃ alkyl, C₄ alkyl, C₅ alkyl, C₆ alkyl, C₇ alkyl, C₈ alkyl or C₉ alkyl independently of each other. Non-limiting examples of alkyl groups include methyl, ethyl, n-propyl, isopropyl, n-butyl, sec-butyl, tert-butyl, isobutyl, 2-ethylbutyl, 3,3-dimethylbutyl, n-pntyl, isopentyl, neopentyl, tert-pentyl, cyclopentyl, 1-methylpentyl, 3-methylpentyl, 2-ethylpentyl, 4-methyl-2-pentyl, n-hexyl, 1-methylhexyl, 2-ethylhexyl, 2-butylhexyl, etc.

In the present disclosure, “—CₙH₂ₙ₊₁” means linear alkyl unless otherwise specified or limited. For example, —C₄H₉ represents n-butyl.

In the present disclosure, “alkoxy” refers to a group with the structure of “—O-alkyl”, that is, the alkyl group as defined above is connected to other groups via oxygen atoms. Suitable examples of phrases containing this term include, but are not limited to, methoxy (—O—CH₃ or —OMe), ethoxy (—O—CH₂CH₃ or —OEt), tert-butoxy (—O—C(CH₃)₃ or —OtBu), n-hexane oxy(—O—C₆H₁₃), N-Decaalkoxy (—O—C₁₀H₂₁), N-Dodecyloxy (—O—C₁₂H₂₅), etc.

In the present disclosure, “amino” represents —NR¹R², wherein R¹ and R² independently represent H or alkyl, that is, the amino might refer to —NH₂, —NH (alkyl) or —N alkyl (alkyl).

In the present disclosure, “halogen” represents —Cl, —Br, —F or —I. Hydroxyl represents —OH. Carboxyl represents —COOH. Nitro represents —NO₂. Sulfonic acid group represents —SO₃H. Sulfhydryl represents —SH. Cyano represents —C≡N.

In the present disclosure, “aryl or aromatic group” refers to an aromatic hydrocarbon group derived by removing a hydrogen atom on the basis of an aromatic ring compound, which might be a monocyclic aromatic group, a condensed aromatic group or a polycyclic aromatic group. For polycyclic ring species, at least one is an aromatic ring system. For example, “substituted or unsubstituted aryl group with 6 to 40 ring atoms” refers to an aryl group containing 6 to 40 ring atoms, and the aryl group may optionally be further substituted. Preferred are substituted or unsubstituted aryl groups with 6 to 30 ring atoms, more preferred are substituted or unsubstituted aryl groups with 6 to 18 ring atoms, particularly preferred are substituted or unsubstituted aryl groups with 6 to 14 ring atoms, and the aryl groups are optionally further substituted. Suitable examples include, but are not limited to, phenyl, biphenyl, terphenyl, naphthyl, anthracenyl, phenanthryl, fluoranthenyl, triphenyl, pyrenyl, perylene, tetraphenyl, fluorenyl, perylene, acenaphthenyl and their derivatives. It might be understood that a plurality of aryl groups might also be interrupted by short non-aromatic units (for example, <10% of non-H atoms, such as C, N or O atoms), such as acenaphthene and fluorene, or 9,9-diaryl fluorene, triarylamine and diaryl ether systems should also be included in the definition of aryl groups.

In the present disclosure, “substituted or unsubstituted” means that the defined group may or may not be substituted. It might be understood that when the group is substituted by substituents, the number of substituents might be one, two, three or more, and when the number of substituents is two or more, each substituent might be the same or different.

In the present disclosure, “number of ring atoms” means the number of ring atoms constituting the ring itself in a structural compound (for example, a monocyclic compound or a polycyclic compound) obtained by synthesizing a ring by atomic bonds, that is, the number of atoms forming a ring. When the ring is substituted by a substituent, the atoms contained in the substituent are not included in the ring atoms. The following “number of ring atoms” is the same without special instructions. For example, the number of ring atoms in benzene ring is 6, the number of ring atoms in naphthalene ring is 10, and the number of ring atoms in thienyl group is 5.

At present, the preparation of quantum dot precursors needs high temperature treatment, and the temperature needs to be kept at 60° C.-100° C. throughout the reaction process until the reaction is over. And it needs to occupy a lot of reaction equipment, which brings a lot of economic and time costs. In addition, high temperature will accelerate the oxidation process and affect the stability and consistency of quantum dot precursors.

The present disclosure discloses a quantum dot precursor. A structural formula of the quantum dot precursor is shown in formula (I):

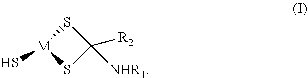

Wherein the M is selected from metal;

R₁ and R₂ are respectively selected from hydrogen, deuterium, halogen, cyano, hydroxyl, carboxyl, aldehyde, nitro, substituted or unsubstituted C₁-C₃₂ alkyl, substituted or unsubstituted C₁-C₃₂ heteroalkyl, substituted or unsubstituted C₂-C₃₂ alkenyl, substituted or unsubstituted C₂-C₃₂ heteroalkenyl, substituted or unsubstituted C₂-C₃₂ alkynyl, substituted or unsubstituted C₂-C₃₂ heteroalkynyl, substituted or unsubstituted C₁-C₃₂ alkoxy, substituted or unsubstituted —NR₃R₄, substituted or unsubstituted —SR₅, substituted or unsubstituted —PR₆R₇, substituted or unsubstituted C₁-C₃₂ acyloxy group, substituted or unsubstituted C₁-C₃₂ alkoxycarbonyl group, substituted or unsubstituted C₆-C₂₀ aryl group, and substituted or unsubstituted heterocyclic groups with 3-20 ring atoms.

R₃, R₄, R₅, R₆ and R₇ are respectively selected from hydrogen, deuterium, halogen, cyano, hydroxyl, carboxyl, aldehyde, nitro, substituted or unsubstituted C₁-C₃₂ alkyl, substituted or unsubstituted C₁-C₃₂ heteroalkyl, substituted or unsubstituted C₂-C₃₂ alkenyl, substituted or unsubstituted C₂-C₃₂ heteroalkenyl, substituted or unsubstituted C₂-C₃₂ alkynyl, substituted or unsubstituted C₂-C₃₂ heteroalkynyl, substituted or unsubstituted C₁-C₃₂ alkoxy, substituted or unsubstituted —PR₆R₇, substituted or unsubstituted C₁-C₃₂ acyloxy group, substituted or unsubstituted C₁-C₃₂ alkoxycarbonyl group, substituted or unsubstituted C₆-C₂₀ aryl group, and substituted or unsubstituted heterocyclic groups with 3-20 ring atoms.

A heteroatom in the heteroalkyl group, the heteroalkenyl group, the heteroalkynyl group and the heterocyclic group is selected from one or more of N, S, O, P and Si.

A substituted substituent in the substituted groups is independently selected from one or more of —NH, —F, —Cl, —Br, —I, —OH, —COOH, —NO₂, —SO₃H, —CHO, —SH, —OH, —OOCCH₃ and —CN.

The quantum dot precursor provided by the present disclosure contains S element and might be used as a sulfur source to synthesize quantum dot. The chain length of R₁ and R₂ in the quantum dot precursor is adjustable, and the selection range of the quantum dot precursor is wide. The preparation method of the quantum dot precursor is simple, and the stability and consistency of the quantum dot precursor might be improved.

In some embodiments, the M is selected from divalent metal.

The divalent metal is selected from one of Zn, Cd, Pb, Hg, Cu, Ni and Mn.

In some embodiments, R₁ and R₂ are respectively selected from hydrogen, deuterium, halogen, cyano, hydroxyl, carboxyl, aldehyde, nitro, substituted or unsubstituted C₅-C₂₀ alkyl, substituted or unsubstituted C₅-C₂₀ heteroalkyl, substituted or unsubstituted C₅-C₂₀ alkenyl, substituted or unsubstituted C₅-C₂₀ heteroalkenyl, substituted or unsubstituted C₅-C₂₀ alkynyl, substituted or unsubstituted C₅-C₂₀ heteroalkynyl, substituted or unsubstituted C₅-C₂₀ alkoxy, substituted or unsubstituted —NR₃R₄, substituted or unsubstituted —SR₅, substituted or unsubstituted —PR₆R₇, substituted or unsubstituted C₃-C₂₀ acyloxy group, substituted or unsubstituted C₅-C₂₀ alkoxycarbonyl group, substituted or unsubstituted C₈-C₂₀ aryl group, and substituted or unsubstituted heterocyclic groups with 5-15 ring atoms.

In some embodiments, R₁ and R₂ are respectively selected from hydrogen, deuterium, halogen, cyano, hydroxyl, carboxyl, aldehyde, nitro, substituted or unsubstituted C₁₀-C₁₅ alkyl, substituted or unsubstituted C₁₀-C₁₅ heteroalkyl, substituted or unsubstituted C₁₀-C₁₅ alkenyl, substituted or unsubstituted C₁₀-C₁₅ heteroalkenyl, substituted or unsubstituted C₁₀-C₁₅ alkynyl, substituted or unsubstituted C₁₀-C₁₅ heteroalkynyl, substituted or unsubstituted C₁₀-C₁₅ alkoxy, substituted or unsubstituted —NR₃R₄, substituted or unsubstituted —SR₅, substituted or unsubstituted —PR₆R₇, substituted or unsubstituted C₅-C₁₅ acyloxy group, substituted or unsubstituted C₅-C₁₅ alkoxycarbonyl group, substituted or unsubstituted C₁₀-C₁₅ aryl group, and substituted or unsubstituted heterocyclic groups with 10-15 ring atoms.

In some embodiments, R₁ and R₂ are respectively selected from hydrogen, deuterium, halogen, cyano, hydroxyl, carboxyl, aldehyde, nitro, substituted or unsubstituted C₁-C₂₀ alkyl, substituted or unsubstituted C₁-C₂₀ heteroalkyl, substituted or unsubstituted C₂-C₂₀ alkenyl, substituted or unsubstituted C₂-C₂₀ heteroalkenyl, substituted or unsubstituted C₂-C₂₀ alkynyl, substituted or unsubstituted C₂-C₂₀ heteroalkynyl, substituted or unsubstituted C₁-C₂₀ alkoxy, substituted or unsubstituted —NR₃R₄, substituted or unsubstituted —SR₅, substituted or unsubstituted —PR₆R₇, substituted or unsubstituted C₁-C₂₀ acyloxy group, substituted or unsubstituted C₁-C₂₀ alkoxycarbonyl group, substituted or unsubstituted C₆-C₁₅ aryl group, and substituted or unsubstituted heterocyclic groups with 3-15 ring atoms.

In some embodiments, R₁ and R₂ are respectively selected from hydrogen, deuterium, halogen, cyano, hydroxyl, carboxyl, aldehyde, nitro, substituted or unsubstituted C₁-C₁₀ alkyl, substituted or unsubstituted C₁-C₁₀ heteroalkyl, substituted or unsubstituted C₂-C₁₀ alkenyl, substituted or unsubstituted C₂-C₁₀ heteroalkenyl, substituted or unsubstituted C₂-C₁₀ alkynyl, substituted or unsubstituted C₂-C₁₀ heteroalkynyl, substituted or unsubstituted C₁-C₁₀ alkoxy, substituted or unsubstituted —NR₃R₄, substituted or unsubstituted —SR₅, substituted or unsubstituted —PR₆R₇, substituted or unsubstituted C₁-C₁₀ acyloxy group, substituted or unsubstituted C₁-C₁₀ alkoxycarbonyl group, substituted or unsubstituted C₆-C₁₀ aryl group, and substituted or unsubstituted heterocyclic groups with 3-10 ring atoms.

In some embodiments, R₃, R₄, R₅, R₆ and R₇ are respectively selected from hydrogen, deuterium, halogen, cyano, hydroxyl, carboxyl, aldehyde, nitro, substituted or unsubstituted C₅-C₂₀ alkyl, substituted or unsubstituted C₅-C₂₀ heteroalkyl, substituted or unsubstituted C₅-C₂₀ alkenyl, substituted or unsubstituted C₅-C₂₀ heteroalkenyl, substituted or unsubstituted C₅-C₂₀ alkynyl, substituted or unsubstituted C₅-C₂₀ heteroalkynyl, substituted or unsubstituted C₅-C₂₀ alkoxy, substituted or unsubstituted C₃-C₂₀ acyloxy group, substituted or unsubstituted C₅-C₂₀ alkoxycarbonyl group, substituted or unsubstituted C₈-C₂₀ aryl group, and substituted or unsubstituted heterocyclic groups with 5-15 ring atoms.

In some embodiments, R₃, R₄, R₅, R₆ and R₇ are respectively selected from hydrogen, deuterium, halogen, cyano, hydroxyl, carboxyl, aldehyde, nitro, substituted or unsubstituted C₁₀-C₁₅ alkyl, substituted or unsubstituted C₁₀-C₁₅ heteroalkyl, substituted or unsubstituted C₁₀-C₁₅ alkenyl, substituted or unsubstituted C₁₀-C₁₅ heteroalkenyl, substituted or unsubstituted C₁₀-C₁₅ alkynyl, substituted or unsubstituted C₁₀-C₁₅ heteroalkynyl, substituted or unsubstituted C₁₀-C₁₅ alkoxy, substituted or unsubstituted C₅-C₁₅ acyloxy group, substituted or unsubstituted C₅-C₁₅ alkoxycarbonyl group, substituted or unsubstituted C₁₀-C₁₅ aryl group, and substituted or unsubstituted heterocyclic groups with 10-15 ring atoms.

In some embodiments, R₃, R₄, R₅, R₆ and R₇ are respectively selected from hydrogen, deuterium, halogen, cyano, hydroxyl, carboxyl, aldehyde, nitro, substituted or unsubstituted C₁-C₂₀ alkyl, substituted or unsubstituted C₁-C₂₀ heteroalkyl, substituted or unsubstituted C₂-C₂₀ alkenyl, substituted or unsubstituted C₂-C₂₀ heteroalkenyl, substituted or unsubstituted C₂-C₂₀ alkynyl, substituted or unsubstituted C₂-C₂₀ heteroalkynyl, substituted or unsubstituted C₁-C₂₀ alkoxy, substituted or unsubstituted C₁-C₂₀ acyloxy group, substituted or unsubstituted C₁-C₂₀ alkoxycarbonyl group, substituted or unsubstituted C₆-C₁₅ aryl group, and substituted or unsubstituted heterocyclic groups with 3-15 ring atoms.

In some embodiments, R₃, R₄, R₅, R₆ and R₇ are respectively selected from hydrogen, deuterium, halogen, cyano, hydroxyl, carboxyl, aldehyde, nitro, substituted or unsubstituted C₁-C₁₀ alkyl, substituted or unsubstituted C₁-C₁₀ heteroalkyl, substituted or unsubstituted C₂-C₁₀ alkenyl, substituted or unsubstituted C₂-C₁₀ heteroalkenyl, substituted or unsubstituted C₂-C₁₀ alkynyl, substituted or unsubstituted C₂-C₁₀ heteroalkynyl, substituted or unsubstituted C₁-C₁₀ alkoxy, substituted or unsubstituted C₁-C₁₀ acyloxy group, substituted or unsubstituted C₁-C₁₀ alkoxycarbonyl group, substituted or unsubstituted C₆-C₁₀ aryl group, and substituted or unsubstituted heterocyclic groups with 3-10 ring atoms.

In some embodiments, the halogen is selected from one or more of fluorine, chlorine, bromine and iodine.

In some embodiments, the alkyl is selected from one or more of methyl, ethyl, isopropyl, tert-butyl and n-octyl.

The alkenyl is selected from one or more of vinyl, propylene and butene.

The alkynyl is selected from one or more of ethynyl, propynyl, pentynyl and heptylynyl

The alkoxy is selected from one or more of methoxy, ethoxy and propoxy.

The acyloxy is selected from one or more of formyloxy, acetoxy, propionyloxy, butyryloxy, octanoyloxy, palmitoyloxy and stearoyloxy.

The alkoxycarbonyl is selected from one or more of methoxycarbonyl, ethoxycarbonyl, propoxycarbonyl, butoxycarbonyl, octyloxycarbonyl, palmyloxycarbonyl and stearyloxycarbonyl.

The aryl group is selected from one or more of phenyl group, p-tolyl group, p-nitrophenyl group, o-methoxyphenyl group, m-methoxyphenyl group, p-methoxyphenyl group and p-nitromethoxyphenyl group.

In some embodiments, R₁ is selected from C₂-C₁₈ alkyl.

In some embodiments, R₂ is selected from substituted or unsubstituted C₁-C₃₂ alkoxy, substituted or unsubstituted —NR₃R₄, substituted or unsubstituted —SR₅, and substituted or unsubstituted —PR₆R₇.

In some embodiments, R₂ is selected from one of —N(C₂H₅)₂, —OC₁₆H₃₃, —SC₁₆H₃₃, and —NHC₁₆H₃₃.

In some embodiments, the quantum dot precursor is selected from one of the following formulas:

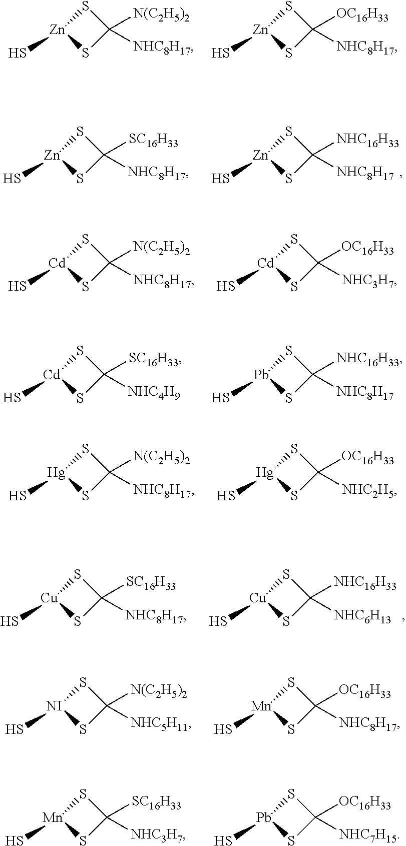

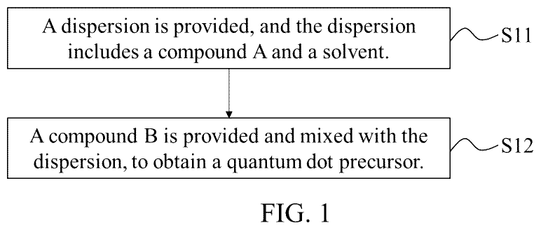

Referring to FIG. 1, the present disclosure proposes a preparation method of a quantum dot precursor which includes step S11-S12.

In step S11, a dispersion is provided, and the dispersion includes a compound A and a solvent.

In step S12, a compound B is provided and mixed with the dispersion, to obtain a quantum dot precursor.

A chemical formula of the compound B is R₉-NH₂.

A structural formula of the compound A is selected from one of formula (II) and formula (III):

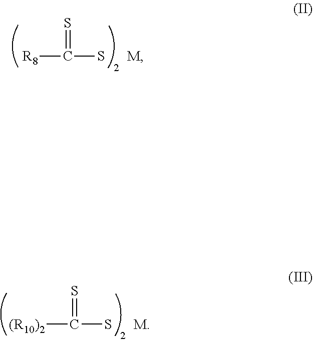

Wherein the M is selected from metal.

R₈, R₉ and R₁₀ are respectively selected from hydrogen, deuterium, halogen, cyano, hydroxyl, carboxyl, aldehyde, nitro, substituted or unsubstituted C₁-C₃₂ alkyl, substituted or unsubstituted C₁-C₃₂ heteroalkyl, substituted or unsubstituted C₂-C₃₂ alkenyl, substituted or unsubstituted C₂-C₃₂ heteroalkenyl, substituted or unsubstituted C₂-C₃₂ alkynyl, substituted or unsubstituted C₂-C₃₂ heteroalkynyl, substituted or unsubstituted C₁-C₃₂ alkoxy, substituted or unsubstituted —NR₃R₄, substituted or unsubstituted —SR₅, substituted or unsubstituted —PR₆R₇, substituted or unsubstituted C₁-C₃₂ acyloxy group, substituted or unsubstituted C₁-C₃₂ alkoxycarbonyl group, substituted or unsubstituted C₆-C₂₀ aryl group, and substituted or unsubstituted heterocyclic groups with 3-20 ring atoms.

R₃, R₄, R₅, R₆ and R₇ are respectively selected from hydrogen, deuterium, halogen, cyano, hydroxyl, carboxyl, aldehyde, nitro, substituted or unsubstituted C₁-C₃₂ alkyl, substituted or unsubstituted C₁-C₃₂ heteroalkyl, substituted or unsubstituted C₂-C₃₂ alkenyl, substituted or unsubstituted C₂-C₃₂ heteroalkenyl, substituted or unsubstituted C₂-C₃₂ alkynyl, substituted or unsubstituted C₂-C₃₂ heteroalkynyl, substituted or unsubstituted C₁-C₃₂ alkoxy, substituted or unsubstituted —PR₆R₇, substituted or unsubstituted C₁-C₃₂ acyloxy group, substituted or unsubstituted C₁-C₃₂ alkoxycarbonyl group, substituted or unsubstituted C₆-C₂₀ aryl group, and substituted or unsubstituted heterocyclic groups with 3-20 ring atoms.

A heteroatom in the heteroalkyl group, the heteroalkenyl group, the heteroalkynyl group and the heterocyclic group is selected from one or more of N, S, O, P and Si.

A substituted substituent in the substituted groups is independently selected from one or more of —NH, —F, —Cl, —Br, —I, —OH, —COOH, —NO₂, —SO₃H, —CHO, —SH, —OH, —OOCCH₃ and —CN.

In some embodiments, R₈, R₉ and R₁₀ are respectively selected from hydrogen, deuterium, halogen, cyano, hydroxyl, carboxyl, aldehyde, nitro, substituted or unsubstituted C₁-C₂₀ alkyl, substituted or unsubstituted C₁-C₂₀ heteroalkyl, substituted or unsubstituted C₂-C₂₀ alkenyl, substituted or unsubstituted C₂-C₂₀ heteroalkenyl, substituted or unsubstituted C₂-C₂₀ alkynyl, substituted or unsubstituted C₂-C₂₀ heteroalkynyl, substituted or unsubstituted C₁-C₂₀ alkoxy, substituted or unsubstituted —NR₃R₄, substituted or unsubstituted —SR₅, substituted or unsubstituted —PR₆R₇, substituted or unsubstituted C₁-C₂₀ acyloxy group, substituted or unsubstituted C₁-C₂₀ alkoxycarbonyl group, substituted or unsubstituted C₆-C₁₅ aryl group, and substituted or unsubstituted heterocyclic groups with 3-15 ring atoms.

In some embodiments, R₉ is selected from C₂-C₁₈ alkyl.

In some embodiments, R₈ and R₁₀ are respectively selected from substituted or unsubstituted C₁-C₃₂ alkoxy, substituted or unsubstituted —NR₃R₄, substituted or unsubstituted —SR₅, and substituted or unsubstituted —PR₆R₇.

In some embodiments, R₈ and R₁₀ are respectively selected from one of —N(C₂H₅)₂, —OC₁₆H₃₃, —SC₁₆H₃₃, and —NHC₁₆H₃₃.

It should be noted that the preparation method of the quantum dot precursor provided by this present disclosure might be carried out at room temperature, and the reaction container might be a sample bottle.

The preparation method of the quantum dot precursor provided by this present disclosure simplifies raw materials and reaction devices, reduces the cost, and the reaction does not need heating, so that the stability of the quantum dot precursor is improved, and the quantum dot precursor is not easy to oxidize, thereby improving the synthesis consistency of the quantum dot precursor.

For the material selection of M, please refer to the above, which will not be repeated here.

For the material selection of R₈ and R₁₀, please refer to the R₂ above, which will not be repeated here.

For the material selection of R₉, please refer to the R₁ above, which will not be repeated here.

In some embodiments, the compound A is selected from one of M(DDTC)₂ (diethyl dithiocarbamates),

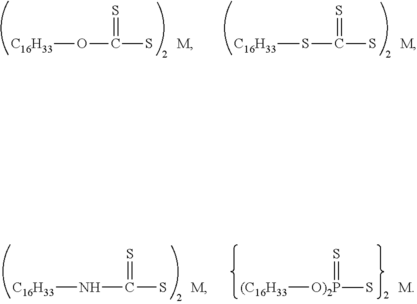

In some embodiments, the compound B is selected from one of n-octylamine, heptamine, ethylamine, butylamine, dodecylamine and octadecylamine.

In some embodiments, the solvent is selected from octadecene (ODE). It might be understood that the selection of the solvent is simplified, which further saves the preparation cost of the quantum dot precursor.

In some embodiments, in the dispersion, a molar concentration of the compound A ranges between 0.05 mmol/mL-0.2 mmol/mL, such as 0.08 mmol/mL, 0.1 mmol/mL, 0.12 mmol/mL, 0.15 mmol/mL, etc. Within the molar concentration range, it is beneficial to the uniform dispersion of the compound A.

In some embodiments, a molar ratio of the compound A to the compound B is 1:(1-4), such as 1:1.5, 1:2, 1:2.5, 1:3, 1:3.5, etc. Within the molar ratio range, it is beneficial to improve the yield of the quantum dot precursor.

In some embodiments, a mixing of the compound A and the compound B is performed under bubbling. It might be understood that under the action of bubbling, it is beneficial for the compound A and the compound B to be fully mixed and contacted to generate a quantum dot precursor.

In some embodiments, a reaction of the compound A and the compound B is performed under room temperature.

In some embodiments, a reaction time of the compound A and the compound B ranges between 2 min-15 min, such as 4 min, 6 min, 8 min, 10 min, 12 min, 14 min, etc.

In some embodiments, a method for mixing the compound B and the dispersion includes: adding the compound B into the dispersion in batches. It might be understood that batch mixing might make the reaction rate controllable and improve the reaction uniformity.

Specifically, a part of the compound B is first added into the dispersion, and after a period of reaction, a rest of the compound B is added.

Illustratively, when the compound A is Zn(DDTC)₂, a reaction formula between Zn(DDTC)₂ and compound B is as follows:

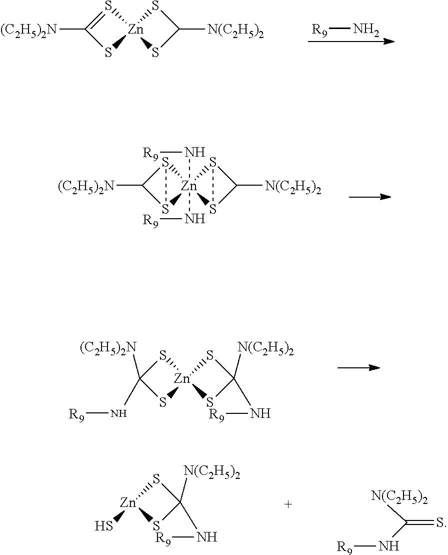

The present disclosure also discloses a quantum dot, and the quantum dot is prepared by the quantum dot precursor above-mentioned.

It might be understood that the quantum dot precursor provided by this present disclosure might be used to synthesize quantum dot. Specifically, the quantum dot precursor might be used to prepare the shell of core-shell quantum dot.

The quantum dot is blue quantum dot. It might be understood that blue quantum dot has poor stability and short life, and need to be improved urgently. When the quantum dot precursor provided by the present disclosure is used for synthesizing blue quantum dot, the stability of the blue quantum dot might be effectively improved and the service life of the blue quantum dot might be prolonged.

Illustratively, a method of synthesizing quantum dot which includes step S13-S14.

In step S13, the quantum dot precursor above-mentioned is added into a solution in which the quantum dot core has been synthesized.

In step S14, reacted to form a quantum dot shell on the surface of the quantum dot core to obtain the quantum dot.

It should be noted that the shell of the core-shell quantum dot is one or more layers, and the quantum dot precursor provided in this present disclosure might be used to synthesize any shell.

This present disclosure will be explained in detail by specific examples. The following examples are only partial examples of this present disclosure, and are not limited to this present disclosure.

### Example 1

This example provides a quantum dot precursor, the structural formula of which is as follows:

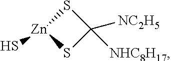

and a preparation method of the quantum dot precursor includes steps S1-S3.

In step S1, a magneton is placed in a 20 mL sample bottle, 1 mmol of Zn(DDTC)₂ (zine diethyldithiocarbamate) is weighed and placed in the sample bottle, and then 10 mL ODE (octadecene) is added into the sample bottle.

In step S2, after bubbling at room temperature for 10 min, 1 mmol of n-octylamine is added, and after reacting for 2 min, 1 mmol of n-octylamine is added, and after reacting for 2 min, the reaction is stopped after the solution is completely dissolved to obtain a mixed solution of quantum dot precursor.

In step S3, the quantum dot precursor is purified by chromatographic column method. The glass column is filled with 300 mesh silica gel, and the silica gel column height is about 15 cm. The mixed solution of the quantum dot precursor is poured into the upper surface of the silica gel column, and chlorobenzene is used as eluent, and a quantum dot precursor is separated after repeated elution.

### Example 2

This example is basically the same as Example 1, only the difference is that in this example, Zn(DDTC)₂ is replaced by

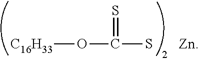

### Example 3

This example is basically the same as Example 1, only the difference is that in this example, Zn(DDTC)₂ is replaced by

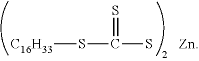

### Example 4

This example is basically the same as Example 1, only the difference is that in this example, Zn(DDTC)₂ is replaced by

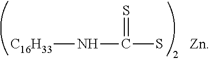

### Example 5

This example is basically the same as Example 1, only the difference is that in this example, Zn(DDTC)₂ is replaced by

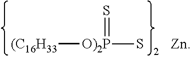

### Example 6

This example is basically the same as Example 1, only the difference is that in this example, Zn(DDTC)₂ is replaced by Cd(DDTC)₂.

### Example 7

This example is basically the same as Example 1, only the difference is that in this example, n-octylamine is replaced by octadecylamine.

### Example 8

This example is basically the same as Example 1, only the difference is that in this example, n-octylamine is replaced by ethylamine.

### Example 9

This example is basically the same as Example 1, only the difference is that in this example, a total of 4 mmol of n-octylamine is added, and the adding method is as follows: adding 1 mmol of n-octylamine, reacting for 2 min, adding 1 mmol of n-octylamine, reacting for 2 min, adding 1 mmol of n-octylamine, reacting for 2 min, and adding the 1 last 1 mmol of n-octylamine.

### Example 10

This example is basically the same as Example 1, only the difference is that in this example, a total of 1 mmol of n-octylamine is added, and the adding method is as follows: adding 1 mmol of n-octylamine, reacting for 2 min.

### Example 11

This example is basically the same as Example 1, only the difference is that in this example, after each addition of n-octylamine, the reaction lasted for 1 min, and the total reaction time is 2 min.

### Example 12

This example is basically the same as Example 1, only the difference is that in this example, after each addition of n-octylamine, the reaction lasted for 7.5 min, and the total reaction time is 15 min.

### Comparative Example 1

This comparative example provides a quantum dot precursor, and a preparation method of the quantum dot precursor includes steps S4-S6.

In step S4, a magneton is placed in a 20 mL sample bottle, 16 mL ODE (octadecene) and 34 ml OAm (oleylamine) are added into the sample bottle, vacuum for 20 min at room temperature, slowly raise the temperature to 120° C. after no obvious bubbles, and continue vacuum for 20 min.

In step S5, 3.44 g Zn(AC)₂ is added until there are no obvious bubbles, keep the vacuum environment, and start cooling after it is completely dissolved and there are no bubbles.

In step S6, when the temperature is reduced to 60° C., 2.26 g of Zn(DDTC)₂ is added, and the reaction continued in vacuum environment until Zn(DDTC)₂ completely reacted, and a quantum dot precursor is obtained.

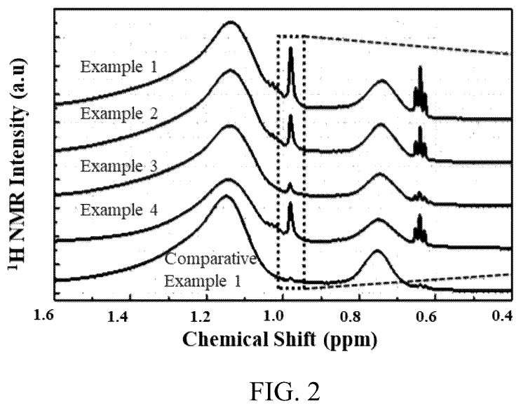

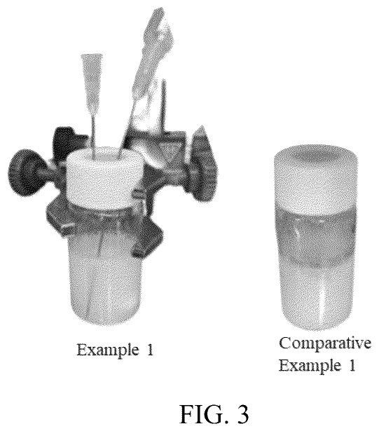

A NMR spectra of quantum dot precursors prepared in Examples 1-4 and Comparative Examples 1 were tested respectively, and the results are shown in FIG. 2. Photographs were taken to record the appearance of the quantum dot precursors prepared in Example 1 and Comparative Example 1, and the results are shown in FIG. 3.

According to FIG. 2, the peak of Comparative Example 1 is relatively weak when the chemical shift is between 0.8 ppm and 1.0 ppm, while the peak of Examples 1-4 is obvious, which shows that the required quantum dot precursor is prepared by the preparation method provided in this present disclosure.

According to FIG. 3, the quantum dot precursor prepared in Example 1 is transparent emulsion without high-temperature heating, while the quantum dot precursor prepared in Comparative Example 1 is oxidized by high-temperature heating, showing light yellow and unstable properties.

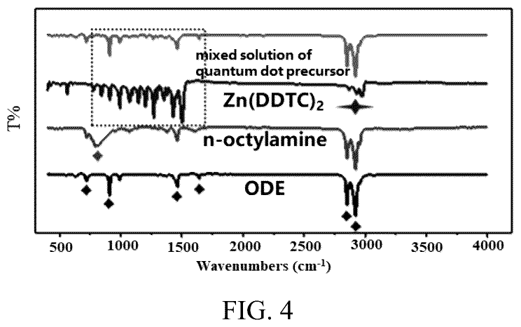

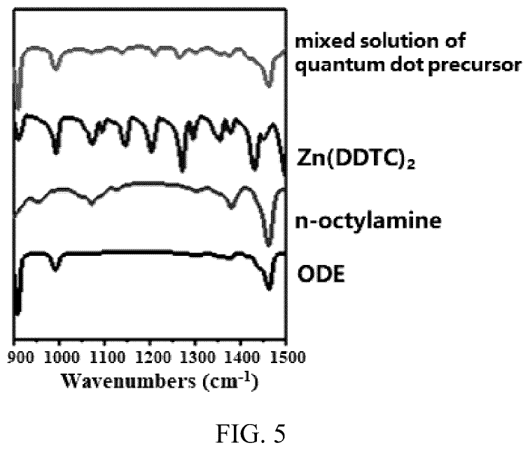

The ODE, n-octylamine, Zn(DDTC)₂ and the mixed solution of quantum dot precursor in Example 1 were tested by Infrared spectrometer (IR), and the results are shown in FIG. 4, FIG. 5 and Table 1.

Infrared spectrometer is an instrument to test the molecular structure and chemical composition by using the characteristic of selective absorption of infrared radiation of different wavelengths by the measured substance. When the sample is irradiated by infrared light, the molecules in the sample absorb some specific wavelengths and cause the change of molecular dipole moment, and the energy level transitions from the ground state to the excited state. The resulting molecular absorption spectrum is called infrared spectrum, also known as molecular vibration rotation spectrum.

TABLE 1

| | | | | mixed solution of |
|---|---|---|---|---|
| | ODE | n-octylamine | Zn(DDTC)₂ | quantum dot precursor |
| Signal-1 | / | 795.5 cm⁻¹ | / | / |
| Signal-2 | / | / | 1147.1 cm⁻¹ | 1140.7 cm⁻¹ |
| Signal-3 | / | / | 1203.4 cm⁻¹ | 1211.2 cm⁻¹ |
| Signal-4 | / | / | 1272.2 cm⁻¹ | 1265.1 cm⁻¹ |
| Signal-5 | / | / | 1296.8 cm⁻¹ | 1303.9 cm⁻¹ |
| Signal-6 | / | / | 2975.0 cm⁻¹ | / |

There is no infrared characteristic absorption peak of n-octylamine in the mixed solution of quantum dot precursor after reaction near 790 cm⁻¹, which indicates that all the added n-octylamine participated in the synthesis of quantum dot precursor. In the range of 900 cm⁻¹-1500 cm⁻¹, the infrared characteristic absorption peak of the mixed solution of quantum dot precursor shifted compared with that of zinc diethyldithiocarbamate, and the characteristic absorption peak near 2975.0 cm⁻¹ in the mixed solution of quantum dot precursor disappeared, which indicated that zinc diethyldithiocarbamate also participated in the synthesis of quantum dot precursors. According to the reaction mechanism of n-octylamine and zinc diethyldithiocarbamate, it can be inferred that the mixed solution of quantum dot precursor contains the target product quantum dot precursor or their homologues. Because there is no standard IR spectrum of the target product, in the range of 900 cm⁻¹-1500 cm⁻¹, the absorption different from solvent and all reactants can be used as the infrared characteristic absorption of the target product or its homologues.

### Quantum Dot Example 1

This example provides a blue quantum dot, and a preparation method of the blue quantum dot includes steps S21-S25.

In step S21, 20 mmol of Zn(OA)₂ solution is put into a three-necked flask, vacuumized at 150° C. until there are no bubbles, switched to argon atmosphere protection, raised the temperature to 330° C., 1 mmol of Se DPP precursor is injected, and after 1 min 0.12 mmol of Cd(OA)₂ precursor is injected, and reacted for 2 h.

In step S22, 3 mmol Se TOP is slowly injected for 2 hours, and the temperature is reduced to 310° C. after the reaction is completed.

In step S23, 2 mmol S TOP and 0.6 mmol Cd(OA)₂ are injected for 20 min, and the temperature as reduced to 120° C. after the reaction is completed.

In step S24, 0.25 mmol of the quantum dot precursor solution of Example 1 is injected for 5 min, and then cooled to 120° C.

In step S25, 40 mL of n-hexane and 40 mL of ethyl acetate are placed in a centrifuge tube, and the above solution is poured into the centrifuge tube, and then 60 mL of ethanol is added, shaken evenly and centrifuged, and the precipitate is the blue quantum dot.

### Quantum Dot Examples 2-12

Quantum dot Examples 2-12 are basically the same as Quantum dot Example 1, and only the difference is that in step S24, the quantum dot precursor of Example 1 is replaced separately by the quantum dot precursor of Examples 2-12.

### Quantum Dot Comparative Example 1

Quantum dot Comparative Example 1 is basically the same as Quantum dot Example 1, and only the difference is that in step S24, the quantum dot precursor of Example 1 is replaced by the quantum dot precursor of Comparative Example 1.

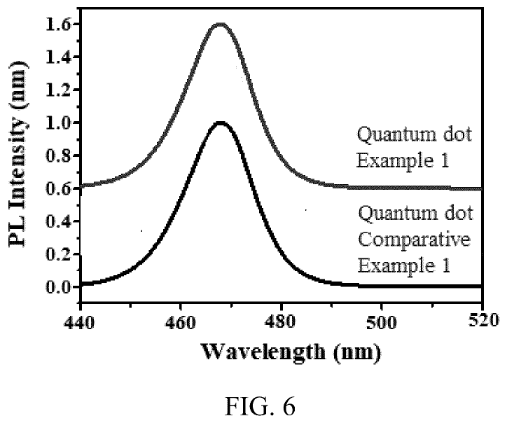

Fifty groups of quantum dots were prepared according to the methods of Quantum Dot Examples 1-12 and Quantum Dot Comparative Example 1. The PL spectrum (photoluminescence spectrum) and EL spectrum (electroluminescence spectrum) of each group of quantum dots were measured, and the photoluminescence spectrum of Quantum Dot Example 1 and Quantum Dot Comparative Example 1 were obtained as shown in FIG. 6. The wavelength average plus or minus standard deviation and the half-peak width average plus or minus standard deviation of Quantum Dot Examples 1-12 and Quantum Dot Comparative Example 1 were recorded, and the results were shown in Table 2.

TABLE 2

| | PL spectrum | | EL spectrum | |
|---|---|---|---|---|
| | | half-peak | | half-peak |
| | wavelength | width | wavelength | width |
| | (nm) | (nm) | (nm) | (nm) |
| Quantum dot | 468.3 ± 0.5 | 16.8 ± 0.3 | 469.0 ± 0.4 | 15.0 ± 0.2 |
| Example 1 | | | | |
| Quantum dot | 468.0 ± 0.2 | 16.6 ± 0.3 | 468.8 ± 0.3 | 15.1 ± 0.3 |
| Example 2 | | | | |
| Quantum dot | 468.2 ± 0.3 | 17.0 ± 0.1 | 469.1 ± 0.1 | 15.3 ± 0.3 |
| Example 3 | | | | |
| Quantum dot | 468.5 ± 0.4 | 16.7 ± 0.2 | 469.2 ± 0.2 | 14.9 ± 0.2 |
| Example 4 | | | | |
| Quantum dot | 467.8 ± 0.2 | 17.1 ± 0.1 | 468.9 ± 0.3 | 15.2 ± 0.1 |
| Example 5 | | | | |
| Quantum dot | 468.4 ± 0.3 | 16.9 ± 0.3 | 469.4 ± 0.4 | 15.1 ± 0.3 |
| Example 6 | | | | |
| Quantum dot | 467.9 ± 0.1 | 16.8 ± 0.4 | 469.3 ± 0.3 | 15.1 ± 0.2 |
| Example 7 | | | | |
| Quantum dot | 468.6 ± 0.4 | 16.9 ± 0.2 | 469.1 ± 0.1 | 15.3 ± 0.1 |
| Example 8 | | | | |
| Quantum dot | 468.8 ± 0.3 | 16.7 ± 0.4 | 469.0 ± 0.2 | 15.2 ± 0.2 |
| Example 9 | | | | |
| Quantum dot | 468.3 ± 0.3 | 16.8 ± 0.1 | 469.1 ± 0.3 | 14.9 ± 0.3 |
| Example 10 | | | | |
| Quantum dot | 467.6 ± 0.4 | 16.8 ± 0.3 | 469.3 ± 0.2 | 14.8 ± 0.1 |
| Example 11 | | | | |
| Quantum dot | 468.1 ± 0.5 | 17.0 ± 0.2 | 469.1 ± 0.4 | 15.1 ± 0.2 |
| Example 12 | | | | |
| Quantum dot | 467.9 ± 3.2 | 16.0 ± 1.2 | 469 ± 2.5 | 15.0 ± 1.0 |
| Comparative | | | | |
| Example 1 | | | | |

According to Quantum dot Examples 1-12 and Quantum dot Comparative example 1, the maximum standard deviation of PL wavelength and PL half-peak width in Quantum dot Examples 1-12 is 0.5 and 0.4, while the maximum standard deviation of PL wavelength and PL half-peak width in Quantum dot Comparative Example 1 is 3.2, which shows that Quantum dot Comparative Example 1 is extremely unstable, and quantum dot precursors affect the stability and consistency of Quantum dot Comparative Example 1.

For the EL spectrum, the maximum standard deviation of EL wavelength in Quantum dot Examples 1-12 is 0.4, and the maximum standard deviation of EL half-peak width is 0.3, while that in Quantum dot Comparative Example 1 is 2.5, and the maximum standard deviation of EL half-peak width is 1.0. The quantum dot precursor provided by the present disclosure is not subjected to high-temperature treatment, and has relatively stable performance and high consistency, so the consistency and stability of the prepared quantum dots are correspondingly improved.

Quantum dot precursor, preparation method thereof and quantum dot are described in detail above. The principles and embodiments of the present disclosure have been described with reference to specific embodiments, and the description of the above embodiments is merely intended to aid in the understanding of the method of the present disclosure and its core idea. At the same time, changes may be made by those skilled in the art to both the specific implementations and the scope of present disclosure in accordance with the teachings of the present disclosure. In view of the foregoing, the content of the present specification should not be construed as limiting the disclosure.

What is claimed is:

1. A quantum dot precursor, a structural formula of the quantum dot precursor is shown in formula (I): 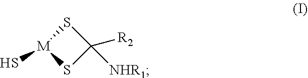
wherein the M is selected from metal;
R₁ and R₂ are respectively selected from hydrogen, deuterium, halogen, cyano, hydroxyl, carboxyl, aldehyde, nitro, substituted or unsubstituted C₁-C₃₂ alkyl, substituted or unsubstituted C₁-C₃₂ heteroalkyl, substituted or unsubstituted C₂-C₃₂ alkenyl, substituted or unsubstituted C₂-C₃₂ heteroalkenyl, substituted or unsubstituted C₂-C₃₂ alkynyl, substituted or unsubstituted C₂-C₃₂ heteroalkynyl, substituted or unsubstituted C₁-C₃₂ alkoxy, substituted or unsubstituted —NR₃R₄, substituted or unsubstituted —SR₅, substituted or unsubstituted —PR₆R₇, substituted or unsubstituted C₁-C₃₂ acyloxy group, substituted or unsubstituted C₁-C₃₂ alkoxycarbonyl group, substituted or unsubstituted C₆-C₂₀ aryl group, and substituted or unsubstituted heterocyclic groups with 3-20 ring atoms;
R₃, R₄, R₅, R₆ and R₇ are respectively selected from hydrogen, deuterium, halogen, cyano, hydroxyl, carboxyl, aldehyde, nitro, substituted or unsubstituted C₁-C₃₂ alkyl, substituted or unsubstituted C₁-C₃₂ heteroalkyl, substituted or unsubstituted C₂-C₃₂ alkenyl, substituted or unsubstituted C₂-C₃₂ heteroalkenyl, substituted or unsubstituted C₂-C₃₂ alkynyl, substituted or unsubstituted C₂-C₃₂ heteroalkynyl, substituted or unsubstituted C₁-C₃₂ alkoxy, substituted or unsubstituted —PR₆R₇, substituted or unsubstituted C₁-C₃₂ acyloxy group, substituted or unsubstituted C₁-C₃₂ alkoxycarbonyl group, substituted or unsubstituted C₆-C₂₀ aryl group, and substituted or unsubstituted heterocyclic groups with 3-20 ring atoms;
a heteroatom in the heteroalkyl group, the heteroalkenyl group, the heteroalkynyl group and the heterocyclic group is selected from one or more of N, S, O, P and Si; and
a substituted substituent in the substituted groups is independently selected from one or more of —NH, —F, —Cl, —Br, —I, —OH, —COOH, —NO₂, —SO₃H, —CHO, —SH, —OH, —OOCCH₃ and —CN.

2. The quantum dot precursor according to claim 1, wherein R₁ and R₂ are respectively selected from hydrogen, deuterium, halogen, cyano, hydroxyl, carboxyl, aldehyde, nitro, substituted or unsubstituted C₁-C₂₀ alkyl, substituted or unsubstituted C₁-C₂₀ heteroalkyl, substituted or unsubstituted C₂-C₂₀ alkenyl, substituted or unsubstituted C₂-C₂₀ heteroalkenyl, substituted or unsubstituted C₂-C₂₀ alkynyl, substituted or unsubstituted C₂-C₂₀ heteroalkynyl, substituted or unsubstituted C₁-C₂₀ alkoxy, substituted or unsubstituted —NR₃R₄, substituted or unsubstituted —SR₅, substituted or unsubstituted —PR₆R₇, substituted or unsubstituted C₁-C₂₀ acyloxy group, substituted or unsubstituted C₁-C₂₀ alkoxycarbonyl group, substituted or unsubstituted C₆-C₁₅ aryl group, and substituted or unsubstituted heterocyclic groups with 3-15 ring atoms.

3. The quantum dot precursor according to claim 1, wherein R₁ is selected from C₂-C₁₈ alkyl.

4. The quantum dot precursor according to claim 3, wherein R₃, R₄, R₅, R₆ and R₇ are respectively selected from hydrogen, deuterium, halogen, cyano, hydroxyl, carboxyl, aldehyde, nitro, substituted or unsubstituted C₁-C₂₀ alkyl, substituted or unsubstituted C₁-C₂₀ heteroalkyl, substituted or unsubstituted C₂-C₂₀ alkenyl, substituted or unsubstituted C₂-C₂₀ heteroalkenyl, substituted or unsubstituted C₂-C₂₀ alkynyl, substituted or unsubstituted C₂-C₂₀ heteroalkynyl, substituted or unsubstituted C₁-C₂₀ alkoxy, substituted or unsubstituted C₁-C₂₀ acyloxy group, substituted or unsubstituted C₁-C₂₀ alkoxycarbonyl group, substituted or unsubstituted C₆-C₁₅ aryl group, and substituted or unsubstituted heterocyclic groups with 3-15 ring atoms.

5. The quantum dot precursor according to claim 1, wherein R₂ is selected from substituted or unsubstituted C₁-C₃₂ alkoxy, substituted or unsubstituted —NR₃R₄, substituted or unsubstituted —SR₅, and substituted or unsubstituted —PR₆R₇.

6. The quantum dot precursor according to claim 1, wherein R₂ is selected from one of —N(C₂H₅)₂, —OC₁₆H₃₃, —SC₁₆H₃₃, and —NHC₁₆H₃₃.

7. The quantum dot precursor according to claim 1, wherein the M is selected from divalent metal, and the divalent metal is selected from one of Zn, Cd, Pb, Hg, Cu, Ni and Mn.

8. The quantum dot precursor according to claim 1, wherein the quantum dot precursor is selected from one of the following formulas:

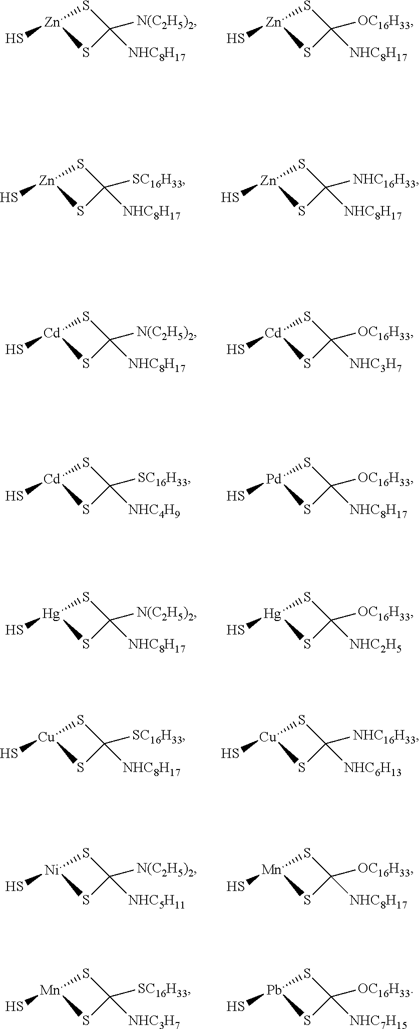

9. A preparation method of a quantum dot precursor, comprising:
providing a dispersion is provided, and the dispersion comprises a compound A and a solvent; and
providing a compound B, mixing the compound B and the dispersion to obtain a quantum dot precursor;
wherein a chemical formula of the compound B is R₉—NH₂; and a structural formula of the compound A is selected from one of formula (II) and formula (III): 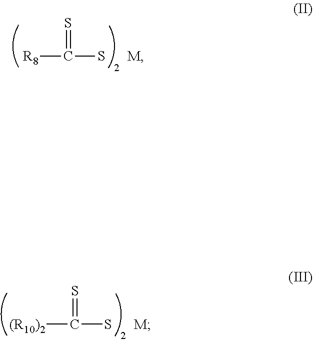
wherein R₈, R₉ and R₁₀ are respectively selected from hydrogen, deuterium, halogen, cyano, hydroxyl, carboxyl, aldehyde, nitro, substituted or unsubstituted C₁-C₃₂ alkyl, substituted or unsubstituted C₁-C₃₂ heteroalkyl, substituted or unsubstituted C₂-C₃₂ alkenyl, substituted or unsubstituted C₂-C₃₂ heteroalkenyl, substituted or unsubstituted C₂-C₃₂ alkynyl, substituted or unsubstituted C₂-C₃₂ heteroalkynyl, substituted or unsubstituted C₁-C₃₂ alkoxy, substituted or unsubstituted —NR₃R₄, substituted or unsubstituted —SR₅, substituted or unsubstituted —PR₆R₇, substituted or unsubstituted C₁-C₃₂ acyloxy group, substituted or unsubstituted C₁-C₃₂ alkoxycarbonyl group, substituted or unsubstituted C₆-C₂₀ aryl group, and substituted or unsubstituted heterocyclic groups with 3-20 ring atoms;
R₃, R₄, R₅, R₆ and R₇ are respectively selected from hydrogen, deuterium, halogen, cyano, hydroxyl, carboxyl, aldehyde, nitro, substituted or unsubstituted C₁-C₃₂ alkyl, substituted or unsubstituted C₁-C₃₂ heteroalkyl, substituted or unsubstituted C₂-C₃₂ alkenyl, substituted or unsubstituted C₂-C₃₂ heteroalkenyl, substituted or unsubstituted C₂-C₃₂ alkynyl, substituted or unsubstituted C₂-C₃₂ heteroalkynyl, substituted or unsubstituted C₁-C₃₂ alkoxy, substituted or unsubstituted —PR₆R₇, substituted or unsubstituted C₁-C₃₂ acyloxy group, substituted or unsubstituted C₁-C₃₂ alkoxycarbonyl group, substituted or unsubstituted C₆-C₂₀ aryl group, and substituted or unsubstituted heterocyclic groups with 3-20 ring atoms;
a heteroatom in the heteroalkyl group, the heteroalkenyl group, the heteroalkynyl group and the heterocyclic group is selected from one or more of N, S, O, P and Si; and
a substituted substituent in the substituted groups is independently selected from one or more of —NH, —F, —Cl, —Br, —I, —OH, —COOH, —NO₂, —SO₃H, —CHO, —SH, —OH, —OOCCH₃ and —CN.

10. The preparation method according to claim 9, wherein R₈, R₉ and R₁₀ are respectively selected from hydrogen, deuterium, halogen, cyano, hydroxyl, carboxyl, aldehyde, nitro, substituted or unsubstituted C₁-C₂₀ alkyl, substituted or unsubstituted C₁-C₂₀ heteroalkyl, substituted or unsubstituted C₂-C₂₀ alkenyl, substituted or unsubstituted C₂-C₂₀ heteroalkenyl, substituted or unsubstituted C₂-C₂₀ alkynyl, substituted or unsubstituted C₂-C₂₀ heteroalkynyl, substituted or unsubstituted C₁-C₂₀ alkoxy, substituted or unsubstituted —NR₃R₄, substituted or unsubstituted —SR₅, substituted or unsubstituted —PR₆R₇, substituted or unsubstituted C₁-C₂₀ acyloxy group, substituted or unsubstituted C₁-C₂₀ alkoxycarbonyl group, substituted or unsubstituted C₆-C₁₅ aryl group, and substituted or unsubstituted heterocyclic groups with 3-15 ring atoms; and
R₃, R₄, R₅, R₆ and R₇ are respectively selected from hydrogen, deuterium, halogen, cyano, hydroxyl, carboxyl, aldehyde, nitro, substituted or unsubstituted C₁-C₂₀ alkyl, substituted or unsubstituted C₁-C₂₀ heteroalkyl, substituted or unsubstituted C₂-C₂₀ alkenyl, substituted or unsubstituted C₂-C₂₀ heteroalkenyl, substituted or unsubstituted C₂-C₂₀ alkynyl, substituted or unsubstituted C₂-C₂₀ heteroalkynyl, substituted or unsubstituted C₁-C₂₀ alkoxy, substituted or unsubstituted C₁-C₂₀ acyloxy group, substituted or unsubstituted C₁-C₂₀ alkoxycarbonyl group, substituted or unsubstituted C₆-C₁₅ aryl group, and substituted or unsubstituted heterocyclic groups with 3-15 ring atoms.

11. The preparation method according to claim 9, wherein R₉ is selected from C₂-C₁₈ alkyl; and
R₈ and R₁₀ are respectively selected from substituted or unsubstituted C₁-C₃₂ alkoxy, substituted or unsubstituted —NR₃R₄, substituted or unsubstituted —SR₅, and substituted or unsubstituted —PR₆R₇; and R₈ and R₁₀ are respectively selected from one of —N(C₂H₅)₂, —OC₁₆H₃₃, —SC₁₆H₃₃, and —NHC₁₆H₃₃.

12. The preparation method according to claim 9, wherein the M is selected from divalent metal, and the divalent metal is selected from one of Zn, Cd, Pb, Hg, Cu, Ni and Mn.

13. The preparation method according to claim 9, wherein the compound A is selected from one of M(DDTC)₂,

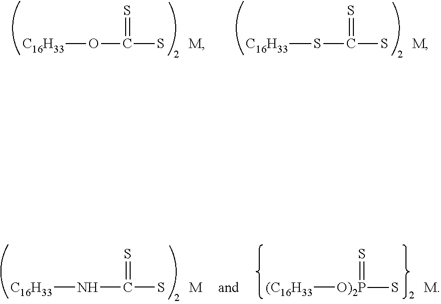

14. The preparation method according to claim 9, wherein the compound B is selected from one of n-octylamine, heptamine, ethylamine, butylamine, dodecylamine and octadecylamine.

15. The preparation method according to claim 9, wherein the solvent is selected from octadecene.

16. The preparation method according to claim 9, wherein a molar concentration of the compound A in the dispersion ranges between 0.05 mmol/mL-0.2 mmol/mL; and a molar ratio of the compound A to the compound B is 1:(1-4).

17. The preparation method according to claim 9, wherein a mixing of the compound A and the compound B is performed under bubbling;
a reaction of the compound A and the compound B is performed under room temperature; and
a reaction time of the compound A and the compound B ranges between 2 min-15 min.

18. The preparation method according to claim 9, wherein a method for mixing the compound B and the dispersion comprises: adding the compound B into the dispersion in batches.

19. A quantum dot, wherein the quantum dot is prepared from the quantum dot precursor according to claim 1.

20. The quantum dot according to claim 19, wherein the quantum dot is a core-shell quantum dot, and a shell layer of the core-shell quantum dot is prepared from the quantum dot precursor; and
the quantum dot is blue quantum dot.
